(19) United States
(12) Patent Application Publication
(10) Pub. No.: US 2006/0103242 A1
(43) Pub. Date: May 18, 2006

(54) Uninterruptible power supply facility

(76) Inventor: Jui Feng Lin, Yuenlin Hsien (TW)

Correspondence Address: CHARLES E. BAXLEY, ESQ., 90 JOHN STREET, THIRD FLOOR, NEW YORK, NY, 10038, US

(21) Appl. No.: 11/158,707

(22) Filed: Jun. 21, 2005

(30) Foreign Application Priority Data
Nov. 15, 2004 (TW) 093218264

(51) Int. Cl. H02J 9/00

(52) U.S. Cl. 307/66

(57) ABSTRACT

An uninterruptible power supply facility includes an input for receiving external electric power energy, an output for outputting a stabilized electric energy to energize electric facilities, and one or more internal batteries coupled to a stabilizing device and a transformer and an internal battery charging device and an uninterruptible power supply system control device, which may control the internal battery charging device to charge the internal battery. An external battery charging device includes one or more sockets for receiving and for charging one or more rechargeable batteries. A pulse width modulation control device may maximize the electric energy transmission.

### BACKGROUND OF THE INVENTION

1. Field of the Invention

The present invention relates to an uninterruptible power supply (UPS) facility, and more particularly to an uninterruptible power supply facility having an external battery charging device for charging rechargeable batteries in addition to the uninterruptible power supply system.

2. Description of the Prior Art

Typical uninterruptible power supply (UPS) facilities have been provided and designed for providing stabilized electric power sources to various electric facilities, such as computer facilities, and comprise a control circuit coupled to one or more batteries, for charging the batteries at all times, and for maintaining the electric energy of the batteries to energize the various electric facilities, particularly when the external electric power sources have been cut off suddenly or unanticipatedly.

In addition to the power failure situations or problems, the UPS facilities may also be provided for providing stabilized electric power sources to the electric facilities when the electric voltages have sags, spikes, surges, transients, or noises, or the like formed or generated therein, for preventing the electric facilities from being damaged by the unstable electric power supplies.

However, the typical uninterruptible power supply facilities may only be provided to energize the electric facilities only, but may not be provided and used to charge the other rechargeable batteries, such that the users have to spend additional money to purchase the other battery charging facilities to charge the other rechargeable batteries.

The present invention has arisen to mitigate and/or obviate the afore-described disadvantages of the conventional uninterruptible power supply facilities.

### SUMMARY OF THE INVENTION

The primary objective of the present invention is to provide an uninterruptible power supply facility including an external battery charging device for charging rechargeable batteries in addition to the uninterruptible power supply system.

In accordance with one aspect of the invention, there is provided a uninterruptible power supply facility comprising an input for coupling to an external electric power source, to receive an electric energy therefrom, an output for outputting a stabilized electric energy to energize electric facilities, at least one internal battery, a stabilizing unit and a transformer coupled between the input and the internal battery, an internal battery charging unit coupled to the internal battery, an uninterruptible power supply system control unit coupled to the internal battery charging unit, to control the internal battery charging unit to charge the internal battery, and an external battery charging unit coupled to the internal battery charging unit, and having at least one socket provided therein for receiving and for charging at least one rechargeable battery.

A converter may further be provided and coupled between the external battery charging unit and the internal battery charging unit. A bridge rectifier may further be provided and coupled between the internal battery charging unit and the transformer.

A pulse width modulation control unit may further be provided and coupled to the transformer and the internal battery, for maximizing an electric energy transmission. A converter may further be provided and coupled to the transformer.

A switch may further be provided and coupled between the internal battery and the internal battery charging unit, to control a charging of the internal battery. A housing may further be provided and for receiving the external battery charging unit, and a cover pivotally attached to the housing, for enclosing and shielding the external battery charging unit.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an uninterruptible power supply facility in accordance with the present invention; and

FIG. 2 is a plan schematic view illustrating an electric circuit of the uninterruptible power supply facility.

### DETAILED DESCRIPTION OF THE PREFERRED EMBODIMENT

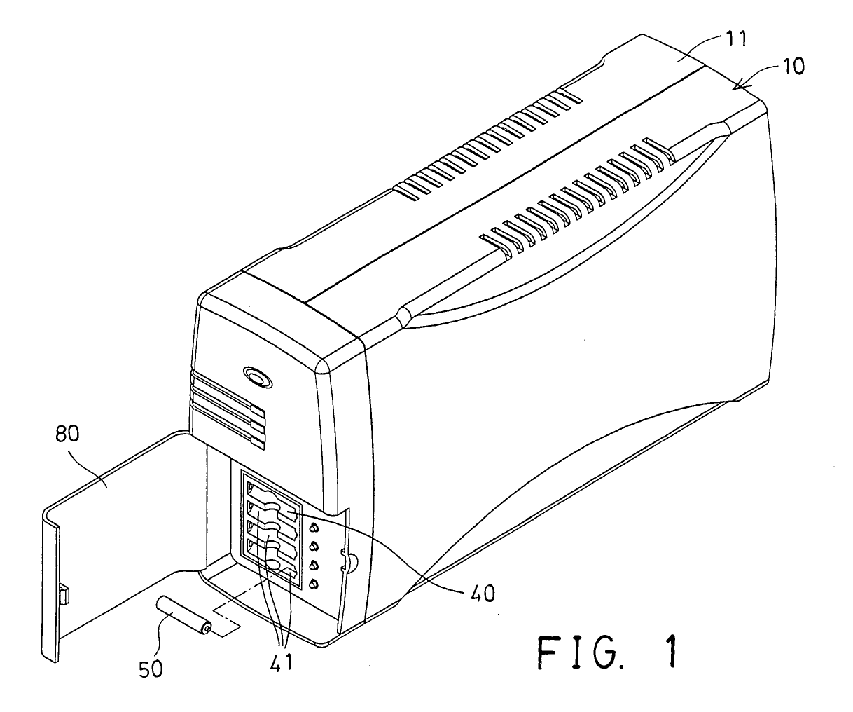

Referring to the drawings, and initially to FIG. 1, an uninterruptible power supply facility 10 in accordance with the present invention comprises a housing 11 for receiving various electrical parts or elements of the uninterruptible power supply facility 10, and for coupling to various electric facilities, such as computer facilities, and for providing stabilized electric power sources or energy to power or to energize the electric facilities.

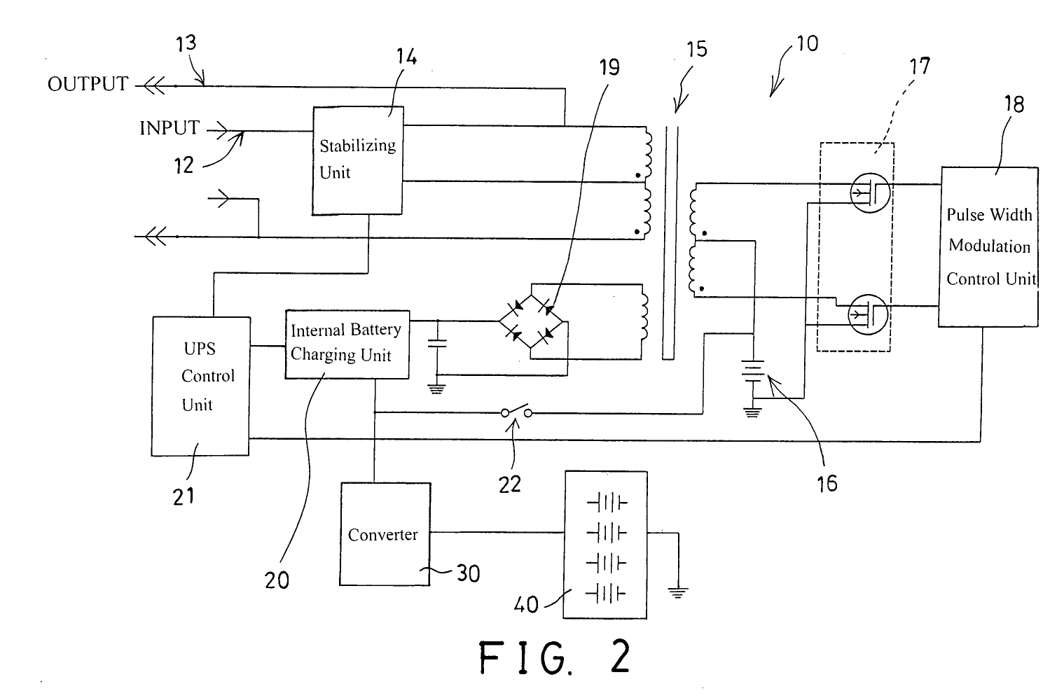

For example, as shown in FIG. 2, the housing 11 includes an input 12 for coupling to an external electric power source, to receive the electric power or energy therefrom, and includes an output 13 for outputting or for supplying the stabilized electric energy to energize the various electric facilities, particularly when the external electric power sources have been cut off suddenly or unanticipatedly.

For example, the uninterruptible power supply facility 10 further includes a stabilizer or stabilizing unit 14 coupled to the input 12, for stabilizing the input electric energy of the external electric power sources, a transformer 15 coupled to the stabilizing unit 14, for transforming the electric energy to the required voltages or the like.

The uninterruptible power supply facility 10 further includes one or more internal batteries 16 coupled to the transformer 15, for being charged or energized by the transformer 15, and a converter 17 and/or a pulse width modulation control unit 18 coupled to the transformer 15 and/or the internal batteries 16, for maximizing the electric energy transmission, and for increasing the working life of the internal batteries 16. Normally, the internal batteries 16 are solidly secured and retained within the housing 11, and may not be removed or disengaged from the housing 11.

The uninterruptible power supply facility 10 further includes a bridge rectifier 19 coupled to an internal battery charging unit 20 which is coupled to the internal batteries 16, or coupled between the internal battery charging unit 20 and the transformer 15, and an uninterruptible power supply system control unit 21 coupled to the internal battery charging unit 20 and/or the pulse width modulation control unit 18 and/or the stabilizing unit 14, to control the internal battery charging unit 20 to charge the internal batteries 16, and thus to provide the stabilized electric power energy to energize the electric facilities.

In addition to the conventional uninterruptible power supply system, the uninterruptible power supply facility 10 further includes an external battery charging unit 40 directly coupled to the internal battery charging unit 20 and/or the internal batteries 16, and having one or more slots or sockets 41 provided therein (FIG. 1) for receiving and for charging one or more rechargeable batteries 50.

The external rechargeable batteries 50 may be removed or disengaged from the external battery charging unit 40 of the housing 11, for energizing the other electric facilities, when required. As shown in FIG. 1, the housing 11 may further include a cover 80 pivotally or rotatably attached thereto, to enclosing or shielding the external battery charging unit 40 and/or the external rechargeable batteries 50, to prevent the external rechargeable batteries 50 from being disengaged from the external battery charging unit 40 and the housing 11 inadvertently.

It is preferable that the uninterruptible power supply facility 10 further includes a converter 30, such as a voltage decreasing type converter 30 selectively coupled to the external battery charging unit 40, and/or coupled between the external battery charging unit 40 and the internal battery charging unit 20, for converting or controlling the voltages or electric energy supplied or charged to the external rechargeable batteries 50. A switch 22 may be provided and coupled between the internal batteries 16 and the internal battery charging unit 20 and/or the converter 30, to control the energizing or charging of the internal batteries 16.

It is to be noted that the uninterruptible power supply facility 10 may also be provided and used as an uninterruptible power supply system to provide the stabilized electric power energy to energize the electric facilities, particularly when the external electric power sources have been cut off suddenly or unanticipatedly. Furthermore, the uninterruptible power supply facility 10 further includes an external battery charging unit 40 for charging one or more rechargeable batteries 50 which may be used to energize the other electric facilities, when required.

The conventional uninterruptible power supply facilities failed to provide an uninterruptible power supply system to provide the stabilized electric power energy to energize the electric facilities, and simultaneously an external battery charging unit for charging one or more rechargeable batteries.

Accordingly, the uninterruptible power supply facility includes an external battery charging device for charging rechargeable batteries in addition to the uninterruptible power supply system.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An uninterruptible power supply facility comprising:
an input for coupling to an external electric power source, to receive an electric energy therefrom,
an output for outputting a stabilized electric energy to energize electric facilities,
at least one internal battery,
a stabilizing unit and a transformer coupled between said input and said at least one internal battery,
an internal battery charging unit coupled to said at least one internal battery,
an uninterruptible power supply system control unit coupled to said internal battery charging unit, to control said internal battery charging unit to charge said at least one internal battery, and
an external battery charging unit coupled to said internal battery charging unit, and having at least one socket provided therein for receiving and for charging at least one rechargeable battery.

2. The uninterruptible power supply facility as claimed in claim 1 further comprising a converter coupled between said external battery charging unit and said internal battery charging unit.

3. The uninterruptible power supply facility as claimed in claim 1 further comprising a bridge rectifier coupled between said internal battery charging unit and said transformer.

4. The uninterruptible power supply facility as claimed in claim 1 further comprising a pulse width modulation control unit coupled to said transformer and said at least one internal battery, for maximizing an electric energy transmission.

5. The uninterruptible power supply facility as claimed in claim 1 further comprising a converter coupled to said transformer.

6. The uninterruptible power supply facility as claimed in claim 1 further comprising a switch coupled between said at least one internal battery and said internal battery charging unit, to control a charging of said at least one internal battery.

7. The uninterruptible power supply facility as claimed in claim 1 further comprising a housing for receiving said external battery charging unit, and a cover pivotally attached to said housing, for enclosing and shielding said external battery charging unit.
